(19) United States
(12) Patent Application Publication
(10) Pub. No.: US 2005/0242251 A1
(43) Pub. Date: Nov. 3, 2005

(54) Deskster

(76) Inventors: Dave A. Licht, Pleasant Hill, CA (US); James J. Morgenroth, Livermore, CA (US)

Correspondence Address: DAVE A. LICHT, 3321 Vincent Road, Pleasant Hill, CA, 94523, US

(21) Appl. No.: 10/835,147

(22) Filed: Apr. 29, 2004

(51) Int. Cl. A47H 1/10; A47F 5/08; A47B 96/06; F41B 13/04; B26B 29/02

(52) U.S. Cl. 248/205.1; 206/317

(57) ABSTRACT

The DESKSTER is a holster for a pistol, revolver, knife or the like. The holster boot can be of any manufacture and is solidly mated to a flat plate of any shape with mounting screw holes and or adhesive or both. The DESKSTER is designed to be mounted to any flat surface, particularly upside down under a table or desk, out of sight where it places the gun, knife or the like naturally in the hand for fast ready use.

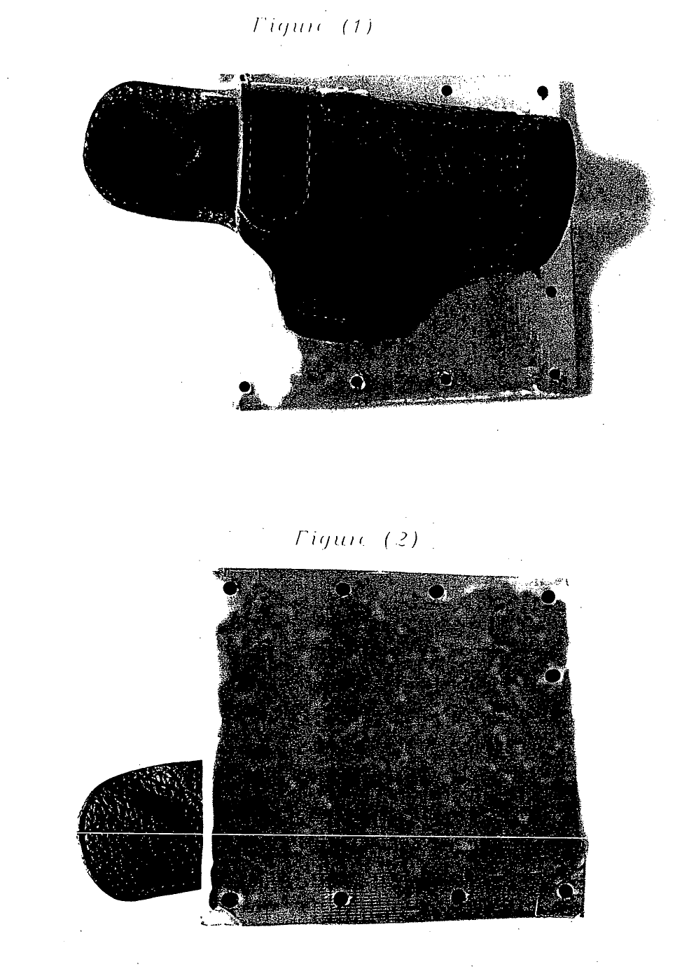

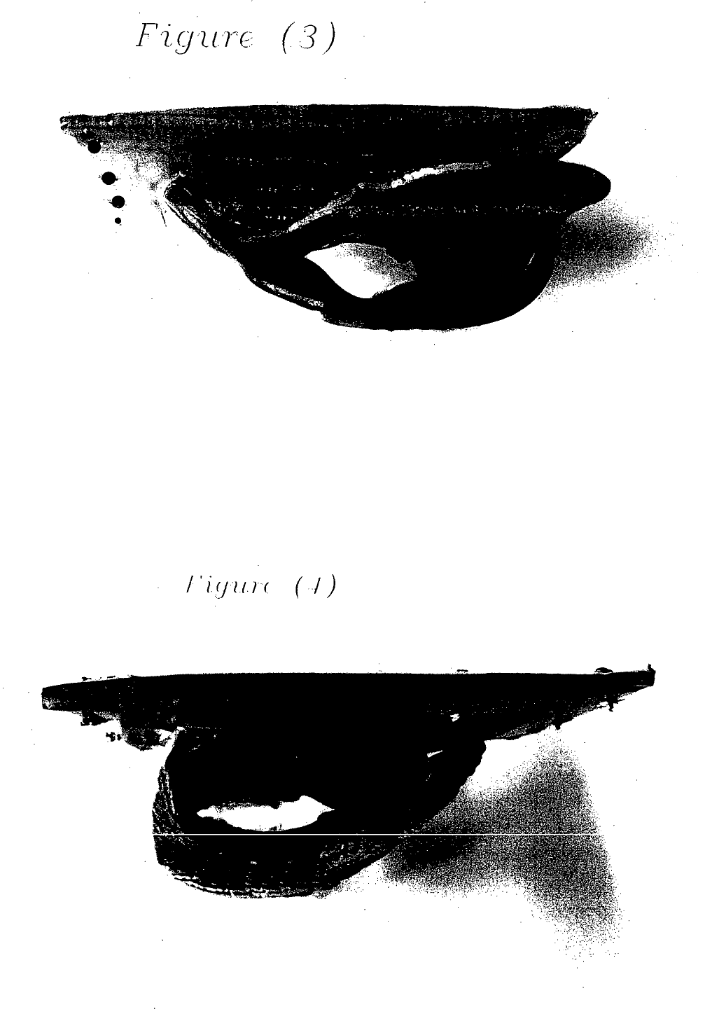

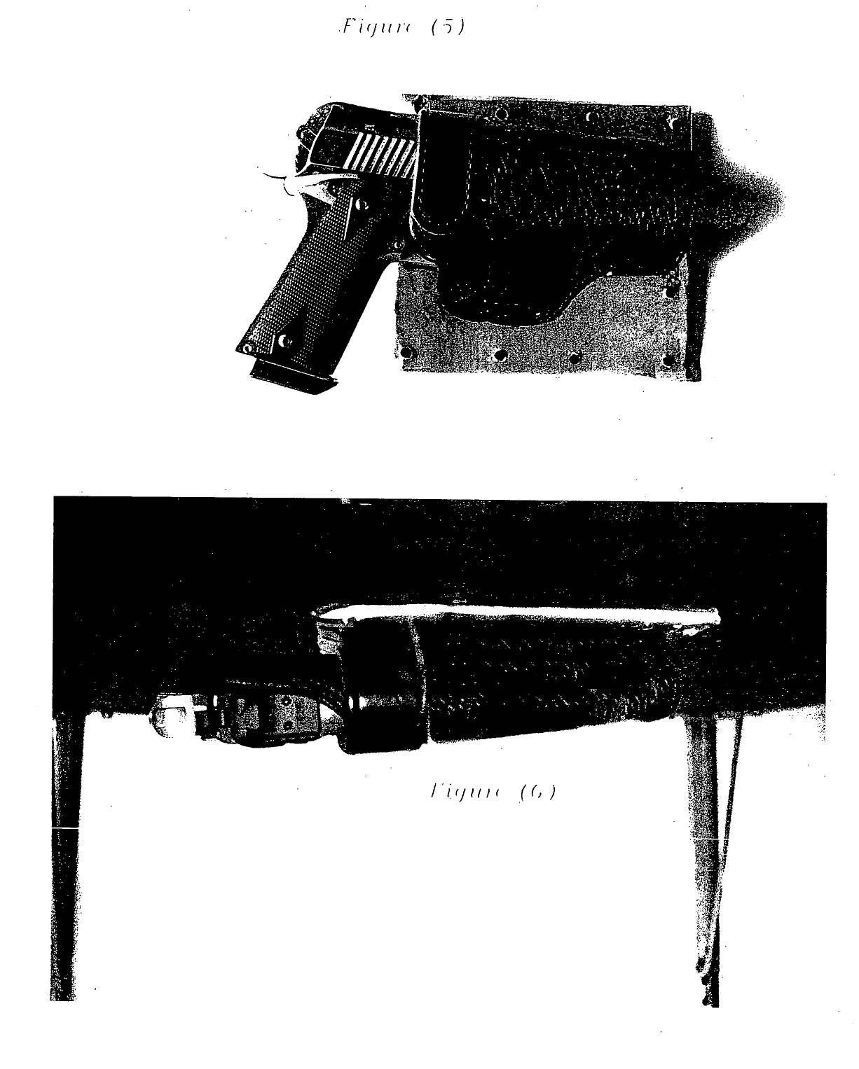

### BACKROUND OF THE INVENTION

In the days of the wild west, Wild Bill Hickock was known to have drilled a hole in the front sight of his revolver and hung it upright under his desk so he would have a revolver between his legs and at hand if someone came gunning for him as he sat at his desk.

The DESKSTER is a holster that can be firmly affixed to the underside of a desk drawer, a table or any flat surface such as the side wall of a desk or counter so that like Wild Bill, the user would have a gun available in hand fast without reaching, standing up or opening a drawer.

### SUMMARY OF INVENTION

The deskster is a holster for a pistol, revolver, knife or the like. The holster boot can be of any manufacture and is solidly mated to a flat plate of any shape with mounting screw holes and or adhesive or both.

The Deskster is designed to be mounted to any flat surface, particularly upside down under a table or desk, out of sight where it places the gun, knife or the like naturally in the hand for fast ready use.

### DESCRIPTION OF PHOTOGRAPHS

FIG. (1) Front perspective view shows a holster mounted to a metal plate with mounting holes for screws

FIG. (2) Rear Perspective view shows the back of the holster showing the flat metal plate which is the mounting surface for the holster to be mounted to the underside of any desk or table

FIG. (3) Top Perspective view Shows the holster from the top and shows the relationship of the holster to the plate being that the holster of any manufacture is solidly surface mounted to the plate and the holster and plate are united as one to be mounted to a solid surface.

FIG. (4) Bottom Perspective view shows the bottom up view and shows the relationship of the holster to the plate being that the holster of any manufacture is solidly surface mounted to the plate and the holster and plate are united as one to be mounted to a solid surface.

FIG. (5) In use view (holding a pistol) shows the relationship of a firearm, knife or the like to the holster in that the firearm, knife or the like is inserted into the holster such that it is ready to draw or use.

FIG. (6) Mounted under table view shows the holster in use in a handgun application, mounted to the underside of a table. The Deskster keeps a firearm, knife or the like out of sight but at hand and ready for instant use.

### FEATURE DESCRIPTION

The DESKSTER features a holster boot for a pistol, revolver, derringer, knife or the like attached to a flat plate giving the holster the ability to mounted to a flat surface.

### DETAILED DESCRIPTION

The DESKSTER is a fast draw holster designed to provide a weapon at hand fast. The design encompasses a holster of any design or manufacture affixed to a flat plate allowing the DESKSTER to be mounted to any flat surface for ready availability of a gun, knife or the like at hand without the need to open a drawer.

1) The DESKSTER is any holster mounted in any manner to a flat plate of any shape or of any material such as metal, leather, Kydex, etc.

2) The DESKSTER can be mounted under a desk or table or to any flat surface such as the inside wall of a desk or any flat surface mount application.

3) The DESKSTER is a fast draw holster designed to keep a gun, knife, tool, device or the like close at the hand of the intended user for fast acquisition.

4) The DESKSTER is a surface mounted holster for guns, knives, tools, devices and the like.

5) The DESKSTER is a personal protection device providing the user with a gun, knife, tool, device or the like in hand while seated at a desk, table or counter.

6) The DESKSTER is a fast draw holster designed to keep a gun, knife, tool device or the like hidden at hand by being mounted under a table, desk, counter and instantly available to the user.

7) The DESKSTER is any holster for any gun, knife, tool, device or the like that mounts to any flat surface.

8) The DESKSTER is any holster for any gun, knife, tool, device or the like that may be affixed to a flat surface be means of adhesive, screws, fasteners alone or in any combination.
